(19) United States
(12) Patent Application Publication
(10) Pub. No.: US 2011/0184956 A1
(43) Pub. Date: Jul. 28, 2011

(54) ACCESSING DIGITALLY PUBLISHED CONTENT USING RE-INDEXING OF SEARCH RESULTS

(75) Inventors: Arkadiy Dantsker, Bothell, WA (US); Justin Saul, Bothell, WA (US)

(73) Assignee: AURUMIS, INC., Bothell, WA (US)

(21) Appl. No.: 13/013,962

(22) Filed: Jan. 26, 2011

Related U.S. Application Data
(60) Provisional application No. 61/336,926, filed on Jan. 27, 2010.

(51) Int. Cl. G06F 17/30

(52) U.S. Cl. 707/741; 707/E17.002

(57) ABSTRACT

Illustrated is a system and method to identify, using an identification module, indexed digitally published content responsive to a search query. The system and method further includes generating an index value, using a indexing engine, based upon a characteristic of the indexed digitally published content. Additionally, the system and method includes re-indexing, using a re-indexing module, the indexed digitally published content based upon the index value.

### CROSS REFERENCE TO RELATED APPLICATIONS

This is a non-provisional patent application claiming priority under 35 USC 119(e) to U.S. Provisional Patent Application No. 61/336,926 on Jan. 27, 2010 entitled “MANAGING NEWS ACCESS USING RE-INDEXING OF SEARCH RESULTS,” which is incorporated by reference in its entirety for any purpose.

### COPYRIGHT

A portion of the disclosure of this document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document. Copyright 2010, Aurumis, Incorporated. All Rights Reserved.

### TECHNICAL FIELD

The present application relates generally to the technical field of algorithms and programming, which can be processed on a computing machine or stored or stored in a computing machine or machine readable media.

### BACKGROUND

Print media is the industry associated with the printing and distribution of digitally published content through digitally published content papers and magazines. These digitally published content papers and magazines are typically subscribed to by readers who receive, as part of their subscription, a physical paper with the digitally published content written to it. With the advent of the internet, much of the digitally published content provided via these digitally published content papers and magazines is provided to readers without a subscription (i.e., free of charge). Additional digitally published content includes publicly available legal documents, academic journals, research reports, and other content that contains, consists of, or is described by text.

### BRIEF DESCRIPTION OF THE DRAWINGS

Some embodiments of the invention are described, by way of example, with respect to the following figures:

FIG. 1 is a diagram of a system, according to an example embodiment, used to serve re-indexed search results.

FIG. 2 is a diagram of a system, according to an example embodiment, used to serve re-indexed search results, where the re-indexed search results are provided by the third-party content server to a device.

FIG. 3 is a diagram of a system, according to an example embodiment, used to update an content index that includes a re-indexed content index store.

FIG. 4 is a diagram of a system, according to an example embodiment, used to generate a message to update dimension tables.

FIG. 5 is a Graphical User Interface (GUI), according to an example embodiment, utilized by a user to search for digitally published content using a subscription management server and re-indexed content.

FIG. 6 is a block diagram of a system, according to an example embodiment, used to generate re-indexed digitally published content.

FIG. 7 is a block diagram of a system, according to an example embodiment, used to generate re-indexed digitally published content using logic encoded as part of computer readable media.

FIG. 8 is a block diagram of a system, according to an example embodiment, used to update a content index.

FIG. 9 is a flow chart illustrating a method, according to an example embodiment, to generate re-indexed digitally published content.

FIG. 10 is a flow chart illustrating a method, according to an example embodiment, to generate re-indexed digitally published content.

FIG. 11 is a flow chart illustrating a method, according to an example embodiment, to used to update a content index.

FIG. 12 is a flow chart illustrating a method, according to an example embodiment, for managing digitally published content subscriptions over a network using re-indexing of content.

FIG. 13 is a flow chart illustrating an operation, according to an example embodiment, to re-index indexed content.

FIG. 14 is a flow chart illustrating a method, according to an example embodiment, to dynamically add a search dimension.

FIG. 15 is a flow chart illustrating an operation, according to an example embodiment, to implement an interactive method to generate dimension keywords.

FIG. 16 is a flow chart illustrating an operation, according to an example embodiment, that can be used to filter keywords that do not belong to the topic keyword set.

FIG. 17 is a flow chart illustrating the execution of a method, according to an example embodiment, to recognize a topic based upon keywords.

FIG. 18 is a flow chart illustrating a method, according to an example embodiment, to determine a user's interests based upon the frequency of keywords.

FIG. 19 is a data base schema, according to an example embodiment, outlining the schema for the content index store.

FIG. 20 is a diagram of an example computer system.

### DETAILED DESCRIPTION

Illustrated is a system and method for managing digitally published content subscriptions over a network using indexing. As used herein, a subscription is a business model where a customer (e.g., a reader) pays a subscription price to have access to the digitally published content. Digitally published content, as used herein, is the communication of current events, the current events represented as digital content. Indexing, as used herein, is the organization of digitally published content using values (i.e., index values) generated based upon rules that utilize weighted dimensions.

In one example embodiment, a paywall, in the form of a subscription management server, regulates a subscription to digitally published content that is reported by a third-party content server. The third-party content server is controlled by a media source such as the New York Times®, Washington Post®, or other suitable media source. A potential reader of the digitally published content provided by the media source has their access to the digitally published content regulated by the paywall. The access may be controlled by having the paywall manage the digitally published content requests sent to the third-party content server. A digitally published content request may be a Hyper Text Transfer Protocol (HTTP) or Secure Hyper Text Transfer Protocol (HTTPS) based request seeking to retrieve digitally published content formatted as a web page. Other data transfer protocols may be used to request and transfer data. Management, as used herein, may include determining whether the potential reader subscribes to the media source. In cases where a subscription does exist, the potential read is allowed access by the paywall to the digitally published content. In cases where a subscription does not exist, the potential read is denied access to the digitally published content.

In one example embodiment, the digitally published content is managed using via a method for indexing and re-indexing search results. For example, the digitally published content reported by the media source via the third-party content server is searched and indexed using a server associated with a search platform such as Google®, Sphinx®, Bing®, or some other suitable search platform. Using the system and method illustrated herein, the result set generated by the search platform is re-indexed to form index values. These index values are generated using or based upon rules that utilize weighted dimensions. This re-indexing allows for granular searches to be performed on the digitally published content served by the third-party content servers. For example, subscribers may be able to tailor their searches based upon criteria that are specific to their digitally published content interests by defining dimensions and weights to be used while searching for digitally published content served by the third-party content server.

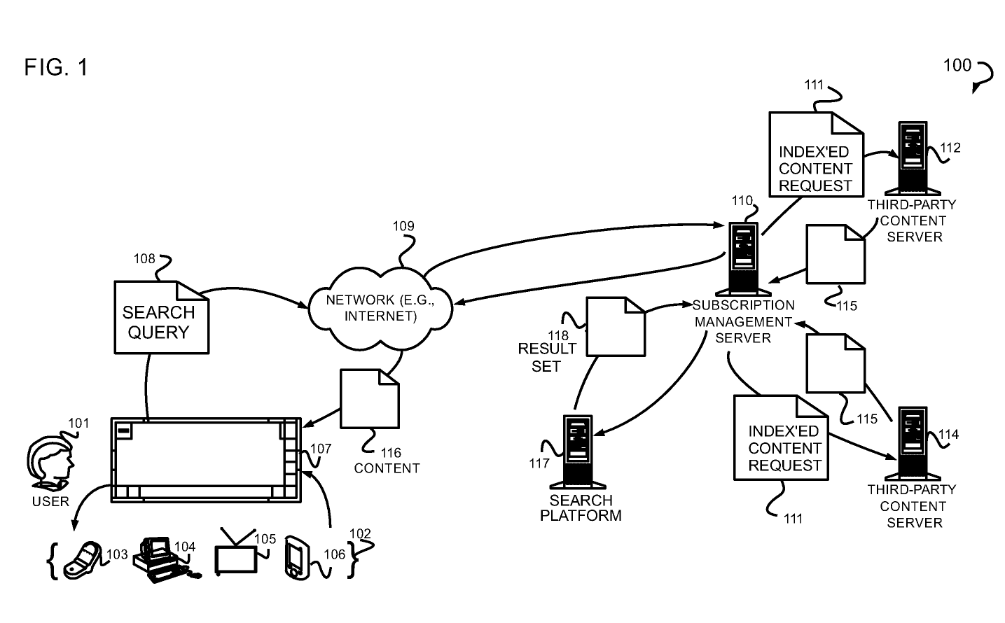

FIG. 1 is a diagram of an example system 100 used to serve re-indexed search results. Shown is a user 101 who utilizing a GUI 107 generates a search query 108. This GUI 107 is generated by one or more devices 102 that include, but are not limited to a cell phone 103 (e.g., mobile phone), computer system 104, television 105, or smart phone 106. The devices 102 can further include electronic devices, portable devices, or other computing machines, In some example embodiments, prior to the generation of the search query 108, the user 101, and device 102 associated therewith, is authenticated to a subscription management server 110. This authentication may take the form of one, two or three factor authentication that may include the use of symmetric or asymmetric keys, challenge questions, biometric identifiers, time or location based authentication, or some other suitable basis or criteria to authenticate the user 101. The authentication demonstrates that the user 101 has a subscription to the digitally published content served by a third-party content server. The search query 108 is transmitted over a network 109 to be received by the subscription management server 110. The network 109 may be a global computer network, an Internet, a local computer network, Local Area Network (LAN), Wide Area Network (WAN), an electronic communication network, or some other suitable network and associated topology. The subscription management server 110 forwards the search query to a search platform 117. This search query 108 is forwarded over, for example, the network 109. Using the search query 108, the search platform 117 searches web pages served by third-party content servers 112 and 114 and indexes these web pages generating a result set 118. The result set 118 includes indexed search results, where these results may be Uniform Resource Locator (URL) links to digitally published content containing web pages served by the third-party content servers 112 and 114. The result set 118 may be formatted using a Hyper Text Markup Language (HTML) or eXtensible Markup Language (XML), or other electronic text format. The result set 118 is received by the subscription management server 110 over, for example, the network 109 and re-indexed using the system and method illustrated herein. This re-indexing includes the generation of index values for each of the new content containing web pages. The index values are generated using dimensions, dimension weights, and indexing rules identifying dimensions, weights, or combinations thereof. Using the re-indexed result set 118, the subscription management server 110 generates a content request in the form of an indexed content request 111 that is transmitted across a network (e.g., the network 109) and received by a third-party content server 112. Based upon the indexed content request 111, content 115 is retrieved and transmitted by the third-party content server 112 to the subscription management server 110. The content 115 may be an XML formatted file that includes URL links to content in the form of digitally published content. As illustrated, in some example embodiments, the index'ed content request 111 is broadcast to a plurality of third-party content servers that include the third-party content server 114. Through broadcasting the index'ed content request 111 the same digitally published content may be retrieved from multiple third-party content servers. The content 115 is formatted as content 116 and provided to one or more of the devices 102 for viewing by the user 101. The content 116 may be a web page or at least one URL linked to a web page, other viable formats, or combinations thereof.

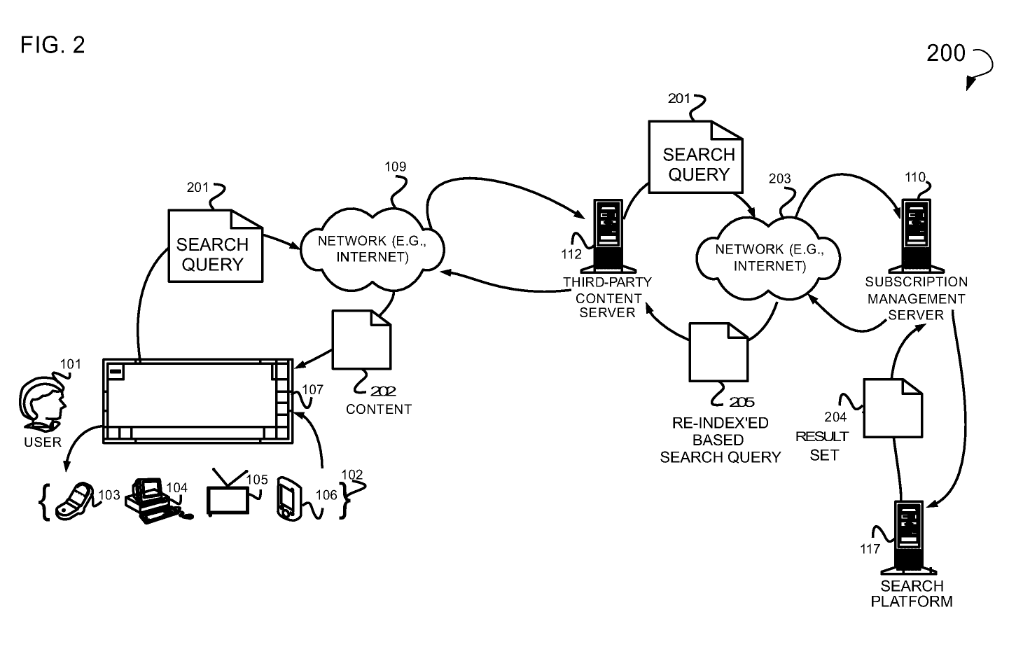

FIG. 2 is a diagram of an example system 200 used to serve re-indexed search results, where the re-indexed search results are provided by the third-party content server to a device. Shown is a search query 201 that is generated using the GUI 107 in conjunction with the one or more devices 102. The search query 201 is transmitted over the network 109 to be received by the third-party content server 112. The search request 201 is forwarded by the third-party content server 112 across the network 203 to the subscription management server 110. Like the network 109, the network 203 may be a global computer network, a local computer network, an electronic communication network, a LAN, WAN, internet, or other suitable network and associated topology. The subscription management server 110 generates an index'ed content request that is transmitted to the search platform 117. The search platform generates a result set 204 that is provided to the subscription management server 110. The result set 204 may be formatted using a HTML XML, or other text format. Using the system and methods illustrated herein, a re-indexed based search query 205 is transmitted by the subscription management server 110 to the third-party content server 112. The third-party content server 112 uses the re-indexed based search query 205 to identify content 202, which can be in the form of web pages with digitally published content, to provide to one or more of the devices 102. The re-indexed based search query 205 may be an HTTP or HTTPS request for a web page that includes an identifier for the one or more devices 102 that generated the search query 201. The content 202 may be a web page that includes digitally published content.

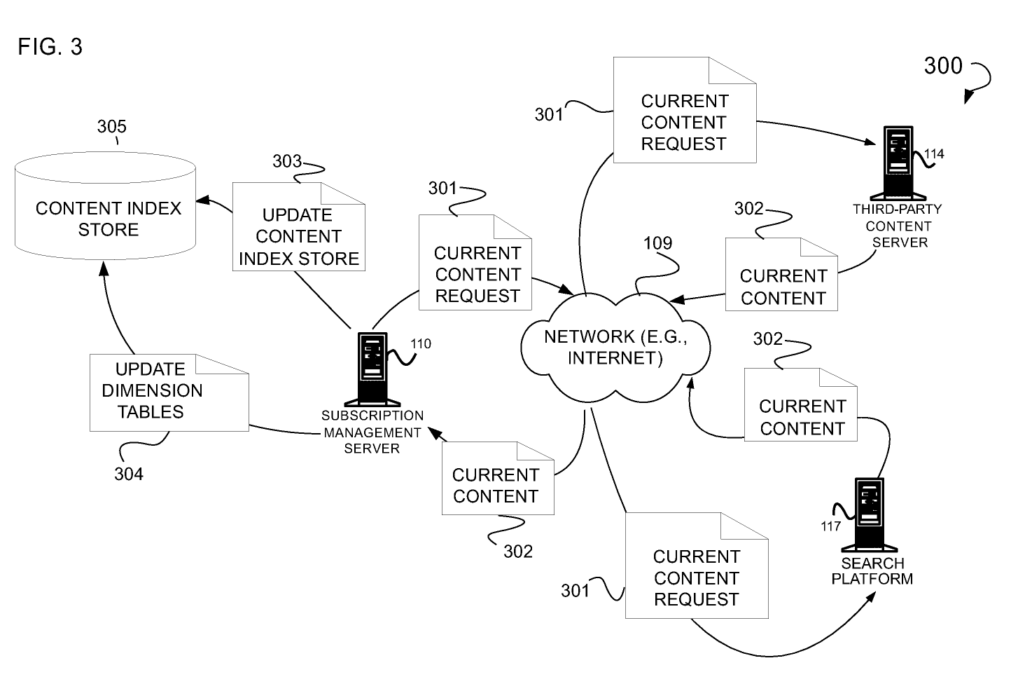

FIG. 3 is a diagram of an example system 300 used to update a content index that includes a re-indexed content index store. In some example embodiments, the updated content included in a content index store 305 is retrieved in response to a search query 108 or 201, in lieu of the re-indexing of the result set 118 or 204. Shown is the subscription management server 110 that generates a current content request 301. This current content request 301 may be generated on a periodic basis or an event driven basis, or combinations thereof. The current content request 301 may be broadcast to a plurality of third-party content servers 114 from which current content is sought. Current content 302 is provided by the third-party content servers 114, or the search platform 117, to the subscription management server 110. Indexed digitally published content is an example of current content 302. The current content 302 may be an XML formatted document that include a list of updated content (i.e., content updated since a prior current content request 301 was received). URL based links to updated content may be included in the current content request 302. Using the current content 302, an updated content index store 303 is generated by the subscription management server 110. The updated content index store 303 may be formatted using XML and may include the URL based links and data base commands (e.g., Structured Query Language (SQL)) used to create, or update entries in the content index store 305 with the URLs for the updated, current content. In some example embodiments, a message in the form of an update dimension table 304 is generated by the subscription management server 110 and provided to the content index store 305 to update dimension, weights and rules used to re-index the result set received from the search platform 117. Dimensions stored in the dimension table may include characteristics or qualities of the data that may link the data to other data.

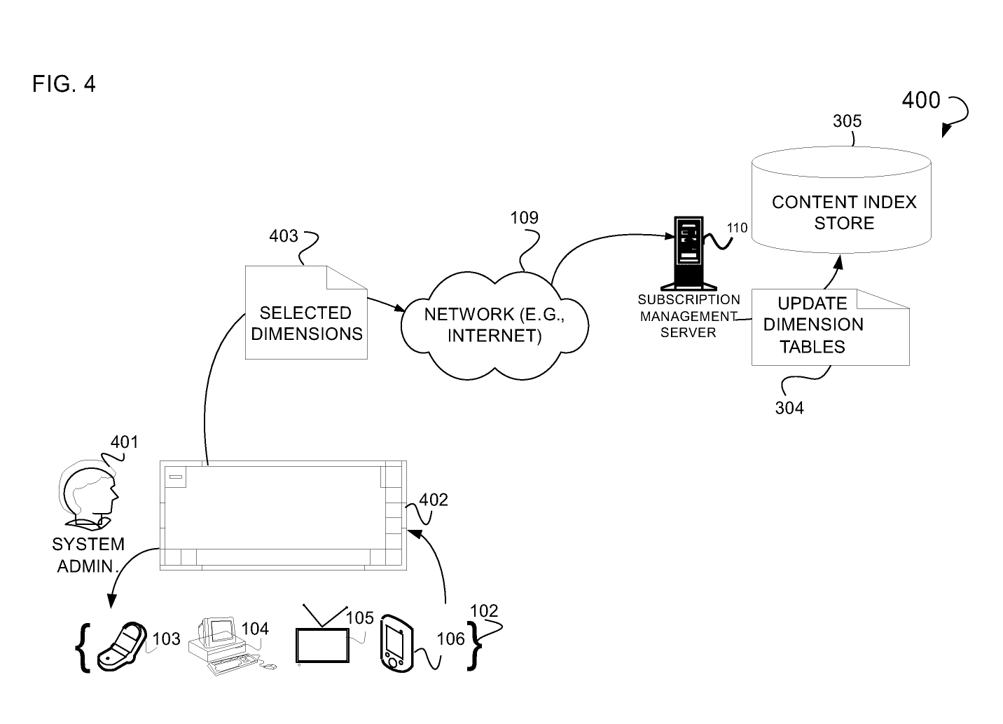

FIG. 4 is a diagram of an example system 400 used to generate a message to update dimension tables. Illustrated is one or more devices 102 utilized by a system administrator 401 to generate a message that includes selected dimensions 403. A GUI 402 may be used to select these dimensions. In some example embodiments, rules and weight values may also be included in the message used to select dimensions (i.e., selected dimensions 403). The selected dimension 403 are transmitted across the network 109 and received by the subscription management server 110. The subscription management server 110 updates the dimensions tables as referenced at 404, where these dimension tables reside as part of the content index store 305. In some example embodiments, the rule and weight values are also updated using the subscription management server 110 to forward updates from the one or more devices 102. The updating of dimension tables, as shown above in FIG. 3 may include the use of XML formatted messages in combination with data base commands.

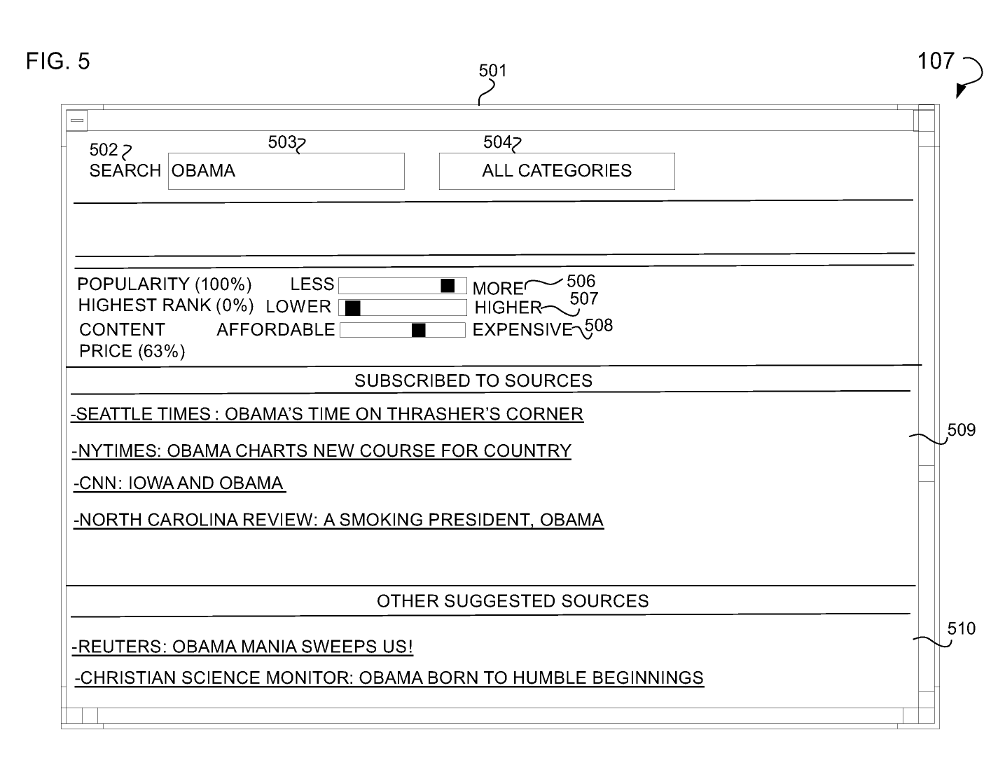

FIG. 5 is an example GUI 107 utilized by a user to search for digitally published content using a subscription management server and re-indexed content. Shown is a GUI 107 that includes a frame 501. Frame 501 may be a structured image on a display (e.g., LCD or other on an electronic machine) that shows certain information or a certain image at any one time. Included in the frame 501 is a field 502 that has a text box 503 that includes search terms. Further, a text box 503 includes search categories. These categories may be the name of a media source, a category of digitally published content (e.g., sports, entertainment, or politics), or some other suitable category. Also shown is a plurality of slide bars 506, 507, and 508. These slide bars may be utilized by the user 101 to assign a weight to the search term relative to a dimension. Also shown are fields 509 and 510. Field 509 shows search results in the form of URLs referencing digitally published content articles provided as part of content 116. Field 510 includes URLs or other links referencing content that is related to the content 116. Related, as used herein, means including common keywords, links, or comments regarding the content.

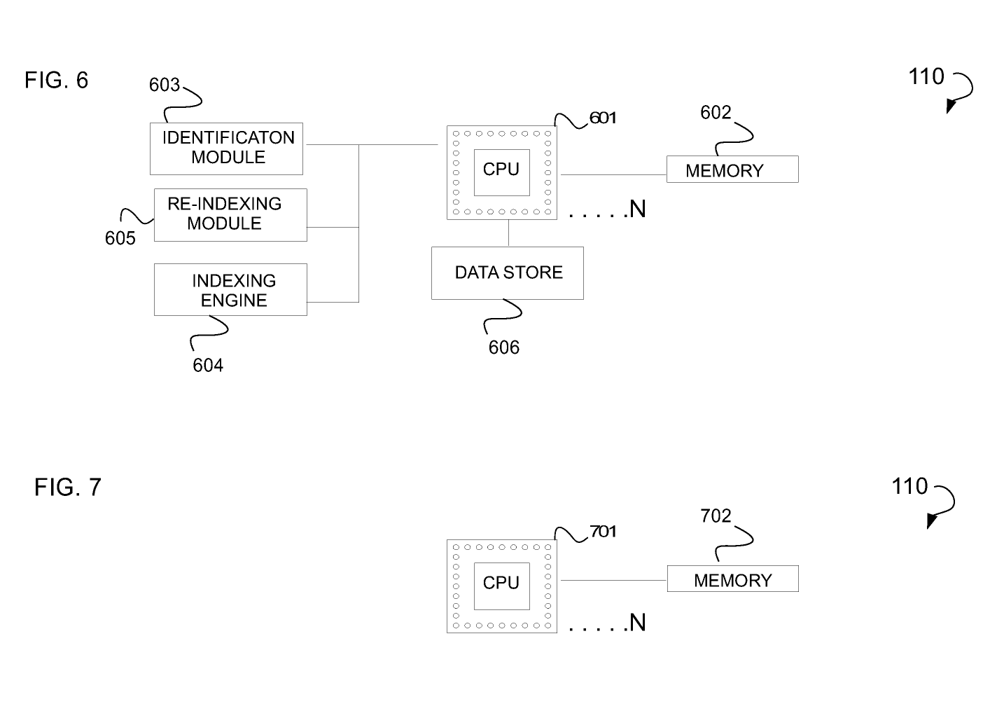

FIG. 6 is a block diagram of an example system 600 used to generate re-indexed digitally published content. An example of the system 600 is the subscription management server 110. The various blocks illustrated herein may be executed as firm ware, hardware, software, or combinations thereof. Additionally, these various blocks may be operatively connected. Operatively connected, as used herein, means a logical or physical connection as well as a data connection, e.g., electrical or optical connection. Accordingly, the various blocks to implement the present disclosure can be in different structures that have a connection. Shown is a processor 601 and memory 602 that are operatively connected. Operatively connected to the processor 601 is an identification module 603 to indexed digitally published content responsive to a search query. Further, operatively connected to the processor 601 is an indexing engine 604 to generate an index value based upon a characteristic of the indexed digitally published content. Moreover, operatively connected to the processor 601 is a re-indexing module 605 to re-index indexed digitally published content based upon the index value. In some example embodiments, the indexed digitally published content is received from the search platform 117. In some example embodiments, the generation of the index value includes the identification of a dimension for the indexed digitally published content, the identification of a weight for the dimension, and determining the index value as the product of the dimension and the weight. Additionally, a rule may be applied to the index value to determine members of a set of values that make up the dimension. The rule may define a relationship between one or more dimensions. In some example embodiments, the members include at least one of keywords, URL links, views, comments, sentences, and web page images. In an example, the relationship of the dimensions may define additional dimensions that can be used to re-index the content. Moreover, the dimensions can be provided with defined values that can be used to weight the search results. The re-indexing module can provide a plurality of different dimensions that can be used to weight the search results, e.g., weights assigned by slider bars 506-508 of FIG. 5. Operatively connected to the processor 601 is a data store 606 to store the index value. Data store 606 can include random access memory, physical media, such as optical drives and magnetic drives, non-volatile memory, tape drive, etc.

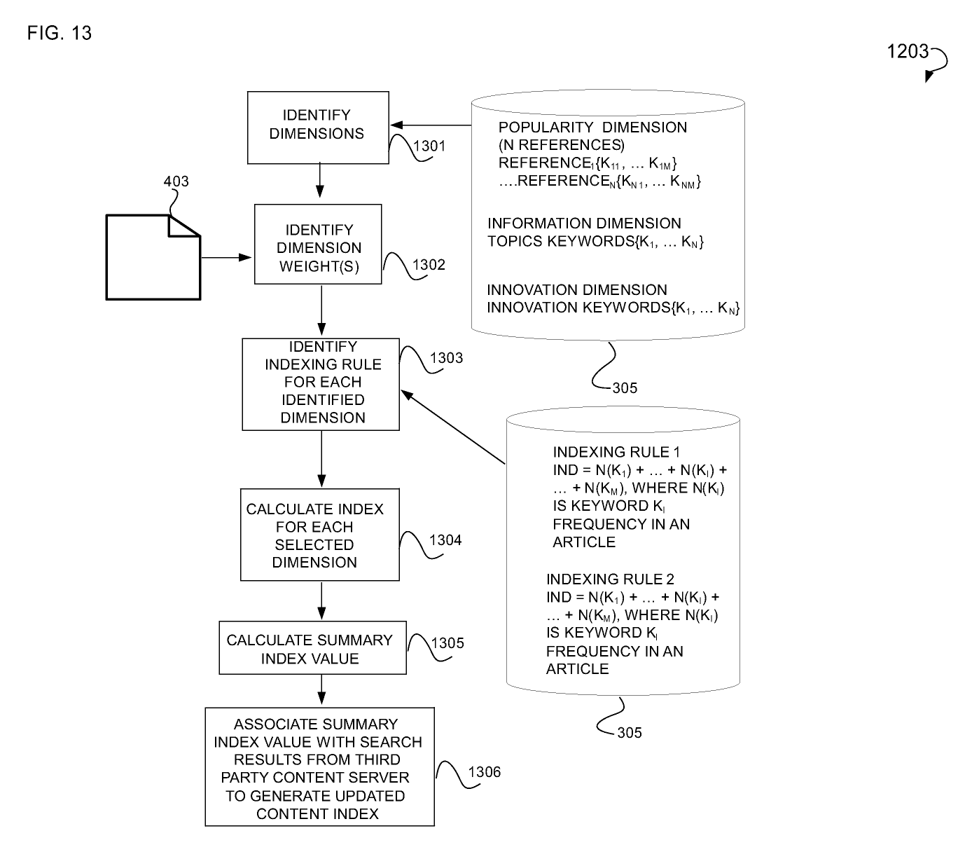

FIG. 7 is a block diagram of an example system 700 used to generate re-indexed digitally published content using logic encoded as part of machine readable media or computer readable media. An example of the system 700 is the subscription management server 110. The various blocks illustrated herein may be executed as firm ware, hardware, software, or combinations thereof. Additionally, these various blocks may be operatively connected. Operatively connected, as used herein, means a logical or physical connection. Shown is a processor 701 and memory 702 that are operatively connected. Included in the memory 702 is logic instructions encoded for execution by the processor 701, and when executed operable to identify indexed digitally published content responsive to a search query. Additionally, the logic is executed to generate an index value based upon a characteristic of the indexed digitally published content. Further, the logic is executed to re-index the indexed digitally published content based upon the index value, but is not limited to any other correlations between the dimensions indexes and weights. For example, the logic may include the ratio of the innovation dimension and informative dimension of the paper like shown in FIG. 13. Another example of calculating the integrated index is to find a deviation of the data. In an example, the calculating uses any arbitrary relationship in index calculating that support business logic. In some example embodiments, the indexed digitally published content is received from a search platform. Moreover, the logic is executed to identify a dimension for the indexed digitally published content. Further, the logic is executed to identify a weight for the dimension. Further, the logic is executed to determine the index value as the product of the dimension and the weight. The logic may also be executed to apply a rule to the index value to determine members of a set of values that make up the dimension. In some example embodiments, the members include at least one of keywords, URL links, views, comments, sentences, and web page images. The logic is also executed to store the index value.

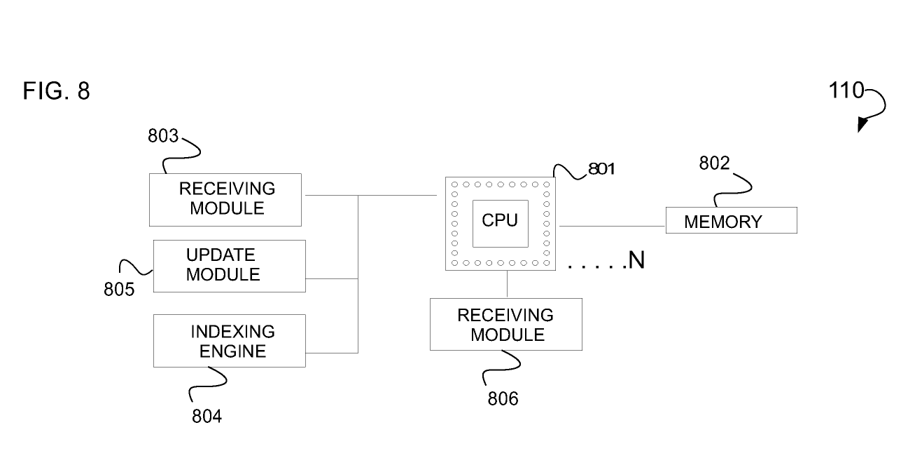

FIG. 8 is a block diagram of an example system 800 used to update a content index. An example of the system 800 is the subscription management server 110. The various blocks illustrated herein may be executed as firm ware, hardware, software, or communications thereof. Additionally, these various blocks may be operatively connected. Operatively connected, as used herein, means a logical or physical connection, or any communication connection. Shown is a processor 801 and memory 802 that are operatively connected. Operatively connected to the processor 801 is a receiving module 803 to receive indexed digitally published content responsive to a current content request. Operatively connected to the processor 801 is an indexing engine 804 to generate an index value based upon a characteristic of the indexed digitally published content. Operatively connected to the processor 801 is an update module 805 to update a content index to reflect the index value for the indexed digitally published content. Operatively connected to the processor 801 is an additional receiving module 806 to receive a search query that identifies the indexed digitally published content. In some example embodiments, the updating module 805 updates the content index to reflect the characteristic as a dimension of the indexed digitally published content. In some example embodiments, the dimension includes at least one of a popularity dimension, an information dimension, an innovation dimension, or any generated dimension. In some example embodiments, the index value is calculated for each dimension. In some example embodiments, the indexed digitally published content includes a URL link to digitally published content. In some example embodiments, the index value is generated, in part, based upon a hash of keywords associated with the indexed digitally published content. In some example embodiments, the index value is generated, in part, based upon a comparison of sets of keywords.

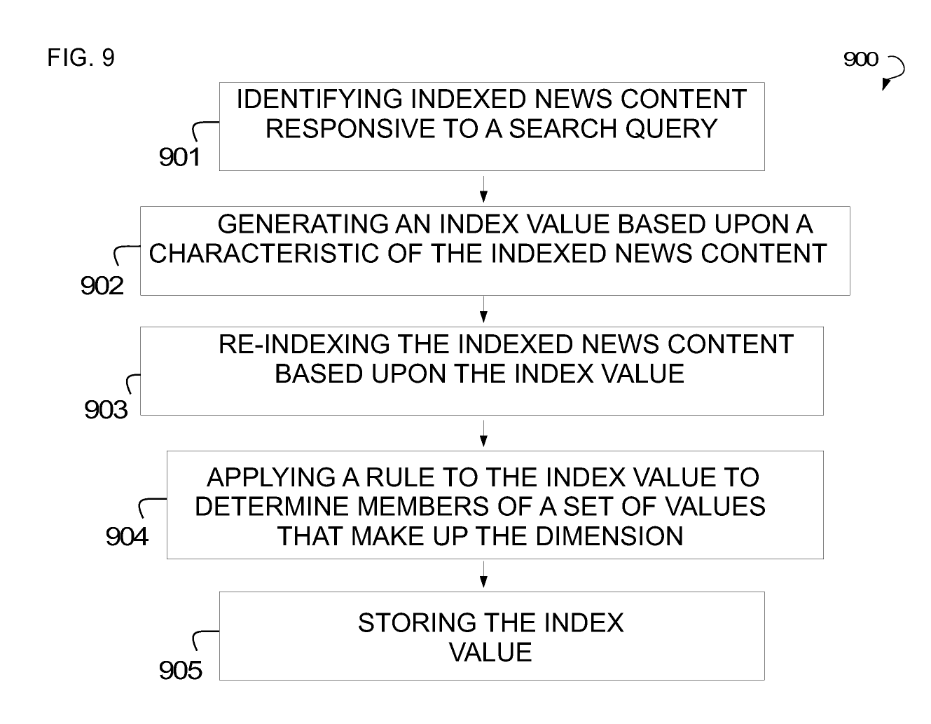

FIG. 9 is a flow chart illustrating an example method 900 to generate re-indexed digitally published content. This method 900 may be executed by the subscription management server 110. An operation 901 is executed by the identification module 603 to identify indexed digitally published content responsive to a search query. Operation 902 is executed by the indexing engine 604 to generate an index value based upon a characteristic of the indexed digitally published content. Operation 903 is executed by the re-indexing module 605 to re-index the indexed digitally published content based upon the index value. In some example embodiments, the indexed digitally published content is received from a search platform. In some example embodiments, the generation of the index value includes identifying a dimension for the indexed digitally published content, identifying a weight for the dimension, and determining the index value as the product of the dimension and the weight. An operation 904 is executed to apply a rule to the index value to determine members of a set of values that make up the dimension. In some example embodiments, the members include at least one of keywords, URL links, views, comments, sentences, and web page images. Operation 905 is executed to store the index value.

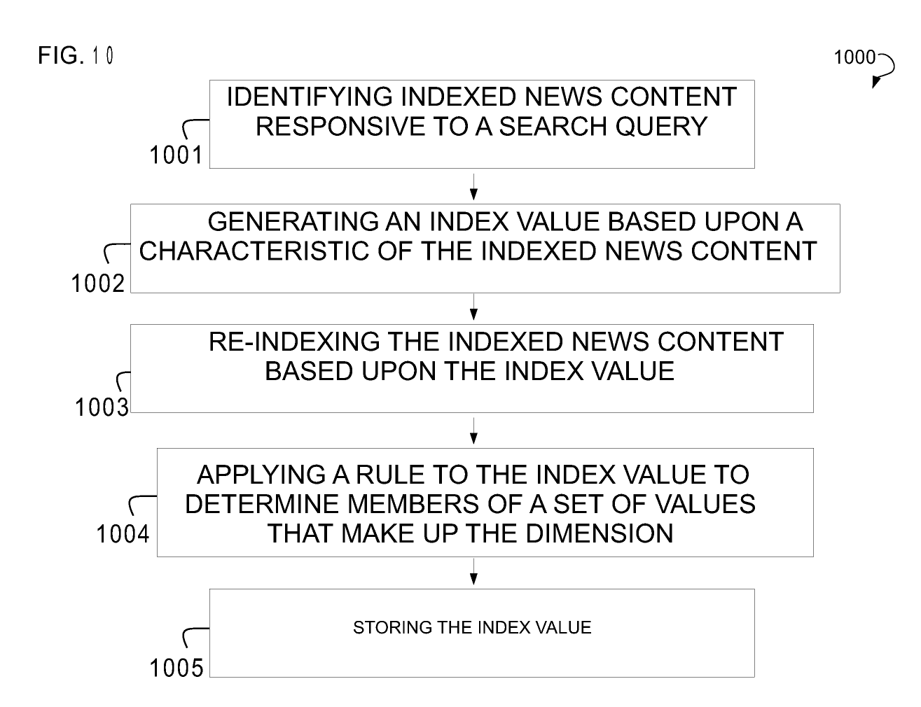

FIG. 10 is a flow chart illustrating an example method 1000 to generate re-indexed digitally published content. This method 1000 may be executed by the subscription management server 110. An operation 1001 is implemented by a processor e.g., processor 701 of FIG. 7, executing logic or instructions encoded in one or more tangible media operable to identify indexed digitally published content responsive to a search query. Operation 1002 is executed by the processor as logic encoded in one or more tangible media operable to generate an index value based upon a characteristic of the indexed digitally published content. Operation 1003 is executed by the processor as logic encoded in one or more tangible media operable to re-index the indexed digitally published content based upon the index value. It will be understood that the above processors can be the same physical processors or separate processors that act together to perform the method 1000, e.g., parallel processors. In some example embodiments, the indexed digitally published content is received from a search platform. In some example embodiments, the generation of the index value includes the logic, which is not limited to any other correlations, when executed, operable to identify a dimension for the indexed digitally published content, identify a weight for the dimension, and determine the index value as the product of the dimension and the weight. Operation 1004 is executed by the processor, e.g., processor 701, as logic encoded in one or more tangible media operable to apply a rule to the index value to determine members of a set of values that make up the dimension. In some example embodiments, the members include at least one of keywords, URL links, views, comments, sentences, and web page images. Operation 1005 is executed by the processor 701 as logic encoded in one or more tangible media operable to store the index value.

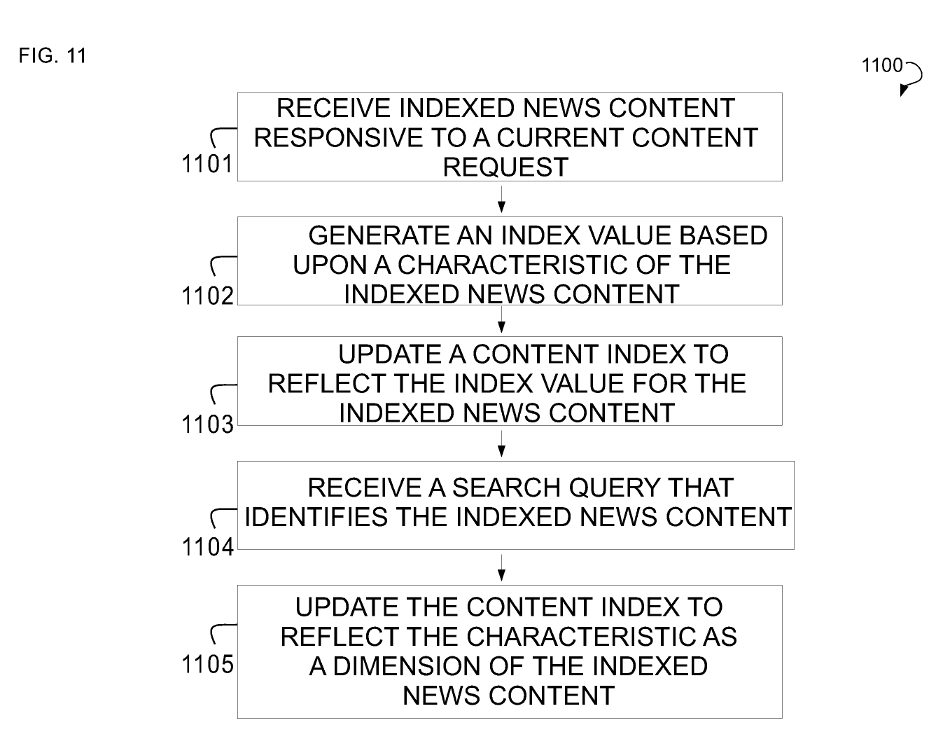

FIG. 11 is a flow chart illustrating an example method 1100 used to update a content index. This method 1100 may be executed by the subscription management server 110 or other device that has a processor and a memory operatively connected to the processor. An operation 1101 is executed by the receiving module 803 to receive indexed digitally published content responsive to a current content request. Operation 1102 is executed by the indexing engine 804 to generate an index based upon a characteristic of the indexed digitally published content. Operation 1103 is executed by the updating module 805 to update a content index to reflect the index value for the indexed digitally published content. Operation 1104 is executed by the additional receiving module 806 to receive a search query that identifies the indexed digitally published content. Operation 1105 is executed by the update module 805 to update the content index to reflect the characteristic as a dimension of the indexed digitally published content. In some example embodiments, the dimension includes at least one of a popularity dimension, an information dimension, or an innovation dimension. In some example embodiments, the index value is calculated for each dimension. In some example embodiments, the indexed digitally published content includes a URL link to digitally published content. In some example embodiments, the index value is generated, in part, based upon a hash of keywords associated with the indexed digitally published content. Further, in some example embodiments, the index value is generated, in part, based upon a comparison of sets of keywords.

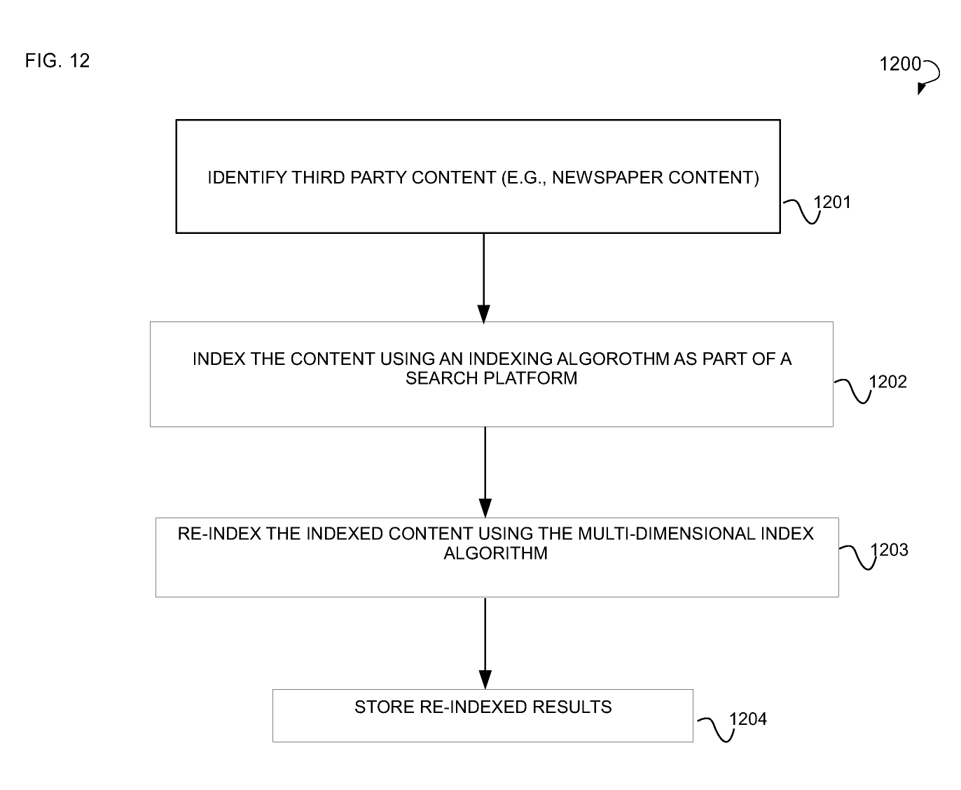

FIG. 12 is a flow chart illustrating an example method 1200 for managing digitally published content subscriptions over a network using re-indexing of content. This method 1200 may be executed by the subscription management server 110 or other device that has a processor and a memory operatively connected to the processor. Operation 1201 is executed to identify third-party content. Identification, as used herein, may include receiving a search query that is searching for digitally published content. Operation 1202 is executed to index the content using an indexing algorithm that is executed as part of a search platform. Operation 1203 is executed to re-index the indexed content using a multi-dimensional index algorithm. Re-indexing, as used herein, includes sorting index generated by the search platform using dimensions, weights and rules. Operation 1204 is executed to store the indexed search results.

FIG. 13 is a flow chart illustrating an example operation 1203 to re-index indexed content. Shown is an operation 1301 that is executed to identify dimensions. These dimensions may be stored in a memory, e.g., the content index store 305. Example dimensions include a popularity dimension, information dimension, innovation dimension, and complexity dimension. The popularity dimension may include the number of URL links to a piece of content (e.g., a digitally published content article), the number of comments regarding an article, the number of views of an article by visitors to a web site, or some other suitable type of popularity. The information dimension may include the number of keywords that a piece of content has, the graphics/images associated with a dimension, or some other suitable type of data that gives information to the user. The innovation dimension may include the commonness of a keyword relative to other keywords, or some other suitable basis. In some example embodiments, the innovation dimension includes keywords or phrase relative to innovation such as: “alternative”, “unique method”, “invention” “innovative”, “break-through” or “first in the world.” In some example embodiments, the dimension includes keywords that are new for a topic or sub-topic. The complexity dimension includes the length of sentences, and number of words in a piece of content, the number of syllables per word, the number of words per paragraph, number of one-letter words, average sentence length, average word length, assigned grade level of words, or some other suitable basis. In an aspect, the complexity dimension can include formulas that use any of the basis described herein, e.g., the Flesch formulas. Complexity dimension can also include illustrations and organization of the content. In another aspect, the complexity dimension can include the Lorge Index or derivatives thereof. These dimensions may be defined by a user, system administrator, or other suitable person.

Operation 1302 is executed to identify dimension weights. In one example embodiment, selected dimensions 403 are provided to the operation 1302. The selected dimensions 403 may be formatted as an XML or flat file that includes numeric values (e.g., weights) that are applied to one or more of the dimensions. Multiple dimensions can be generated from one prototype having similar but not identical rules. This file may be generated prior to the processing of the content 115, or contemporaneously with the processing of the file. Operation 1303 is executed to identify an indexing rule for each of the identified dimensions. An indexing rule, as used herein, is a way to use or process the dimensions. For example, a rule may exist to count a dimension (e.g., to count the number links to determine the popularity dimension). Additionally, a rule may exist to determine whether to use a dimension based upon the age of a piece of content. Additional rules include weighing dimensions applied to a piece of content individually, or a rule to weigh the dimensions in the aggregate. The rules can also perform statistical analysis of the dimensions, e.g., rates of change, comparison to other dimensions, or other sources of dimensional data. Operation 1304 is executed to calculate an index for each selected dimension. For example, when applying the popularity dimension to a piece of content, the number of links in the content can be summed up and the product of the weight times the sum of the links determined. In some example embodiments, the data used to calculate the index is provided as part of the content 115. In some embodiments, the data is retrieved by the subscription management server 110 accessing the content, and parsing the content based upon the selected dimensions. Operation 1305 is executed to determine the summary index value based upon the sum of each of the product determined through the execution of operation 1304. This summary index value is determined for a piece of content such as a web page. Operation 1306 is executed to associate in a data base the summary index value with the search results provided as part of the content 115.

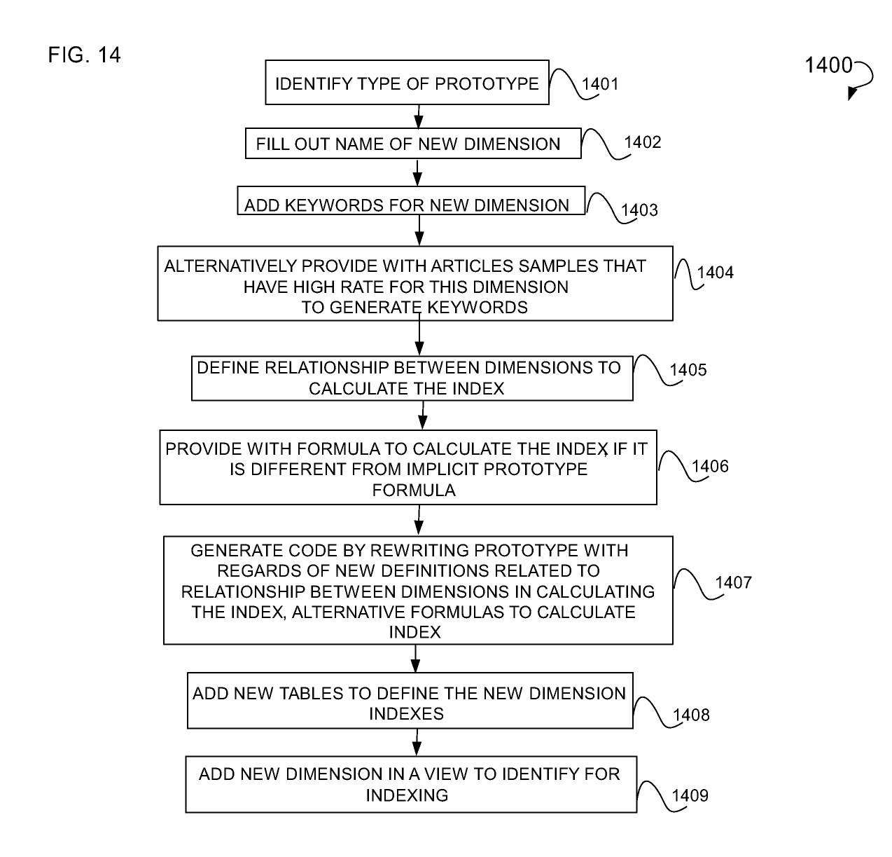

FIG. 14 is a flow chart illustrating an example method 1400 to dynamically add a search dimension. This method 1400 may be executed by the subscription management server 110 or one or more of the devices 102 or other machines, which may include a processor and memory. Shown is an operation 1401 that is executed to identify a prototype. A prototype is a predefined set of rules and serves as a basis to generate a dimension. An XML schema or base class in an object oriented programming language is an example of a prototype. Dimension transformation would define the generic rules for dimension generation. The dimensions can be generated by specifying the element or attributes values from the prototype XML definition and the attributes values are specified from the GUI. Operations 1402 is executed as part of a GUI to allow a user to provide a name for the new dimension. Operation 1403 is executed to add a keyword(s) for a new dimension. Operation 1404 is executed to provide (e.g., upload) a piece of content indicative of the new dimension. Indicative includes having a number of keywords associated with the dimension. Operation 1405 is executed to define relationships between dimensions to calculate an index. In some example embodiments, keywords are shared between dimensions based upon the keywords included in the prototype. The prototype may be extended, enhanced based upon the rule added to the prototype for the additional dimension. The prototype has unique XML or other definition that would serve to generate additional dimensions with DT transformation. Operation 1406 is executed to provide a formula to calculate the index, where the index is distinct from the index implicit in the prototype formula. Distinctness may exist where different weights are applied. Operation 1407 is executed to generate a code template through re-writing the prototype and inserting the new dimensions and formulas into the prototype to generate the search dimension. Operation 1408 is executed to add table to the prototype to define additional dimension indexes. Operation 1409 is executed to add a graphical representation (i.e., a view) to the prototype to identify for indexing.

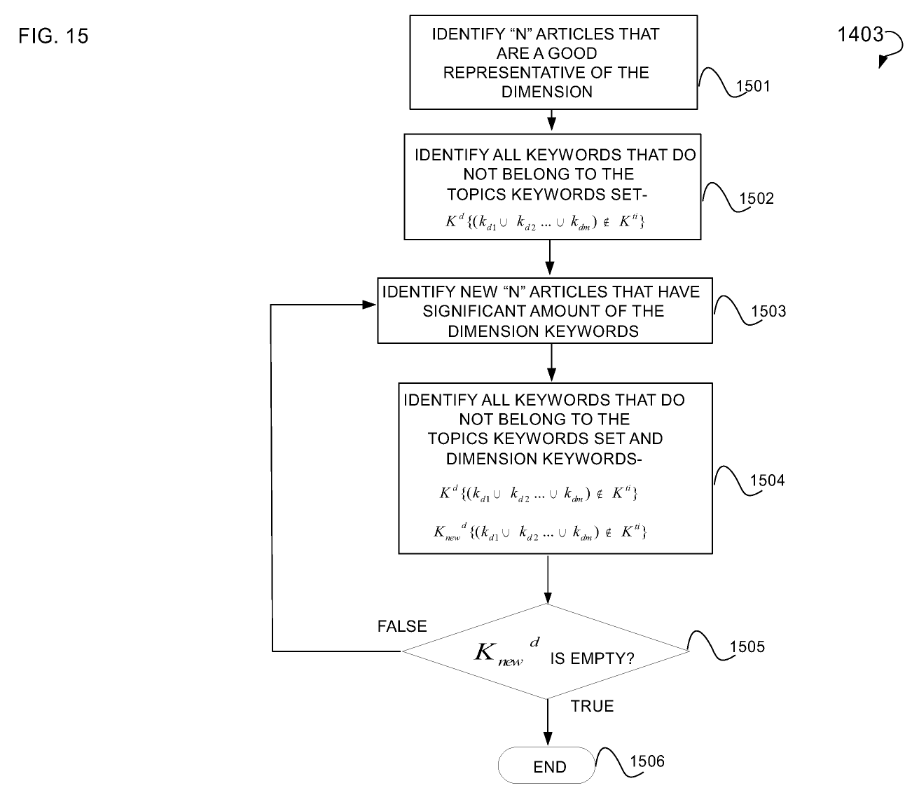

FIG. 15 is a flow chart illustrating an example operation 1403 to implement an interactive method to generate dimension keywords. Operation 1403 is executed to automate the keyword generation process. Operation 1501 is executed to identify “N” articles (i.e., content in the form of digitally published content) that are representative of a dimension. Operation 1502 is executed to identify keywords that do not belong to a keyword set for one or more articles. In some example embodiments, the operation 1502 acts to filter keywords. Operation 1503 is executed to identify “N” articles that have a significant amount of dimension keywords. Significance, as used herein, is a numeric value determined by a system administrator or other suitable individual. In an aspect, significance can be a statistically important value that can be computed. Operation 1504 is executed to identify keywords that do not belong to the set of keywords identified at operation 1503. Operation 1504 may be executed via a set difference operation. A decision operation 1505 is executed to determine whether the set of articles for the dimension is empty. Where decision operation 1505 evaluates to “false,” operation 1503 is re-executed. Where decision operation 1505 evaluates to “true,” a termination operation 1506 is executed.

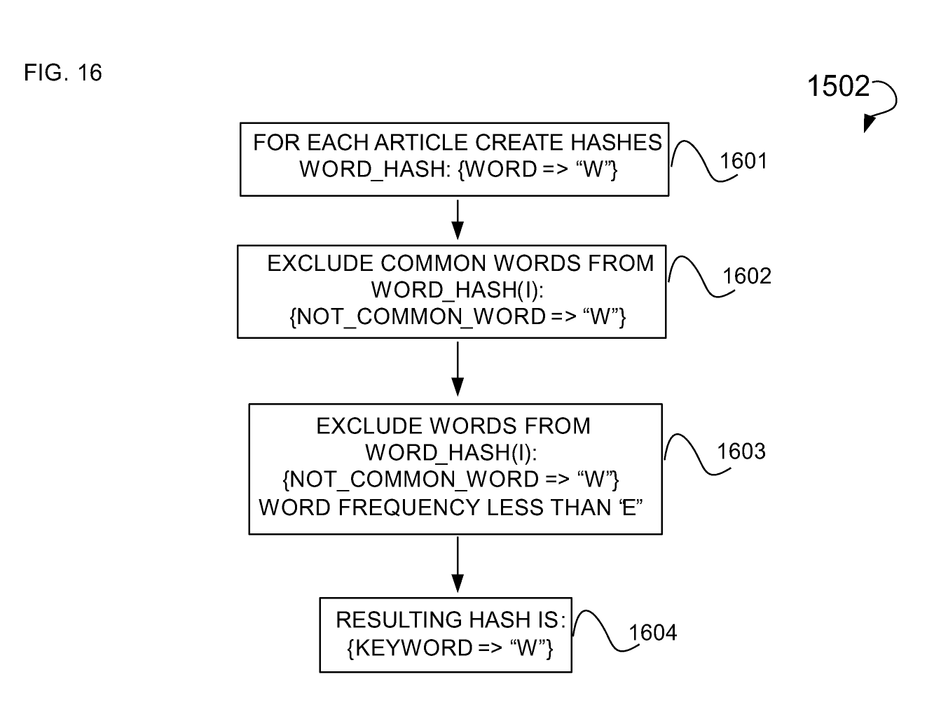

FIG. 16 is a flow chart illustrating an example operation 1502 that can be used to filter keywords that do not belong to the topic keyword set. Operation 1601 is executed to create a hash set that includes each word in an article. Operation 1602 is executed to exclude common words from the hash set. Common words are defined by a file that contains a list, a system administrator, or other suitable person, and included in common word set. Operation 1603 is executed to exclude words with a high frequency, where this frequency is determined by a system administrator or other suitable person. A frequency, as used herein, is a numeric value. Operation 1604 is executed to generate a hash of the remaining keywords after the execution of operation 1603.

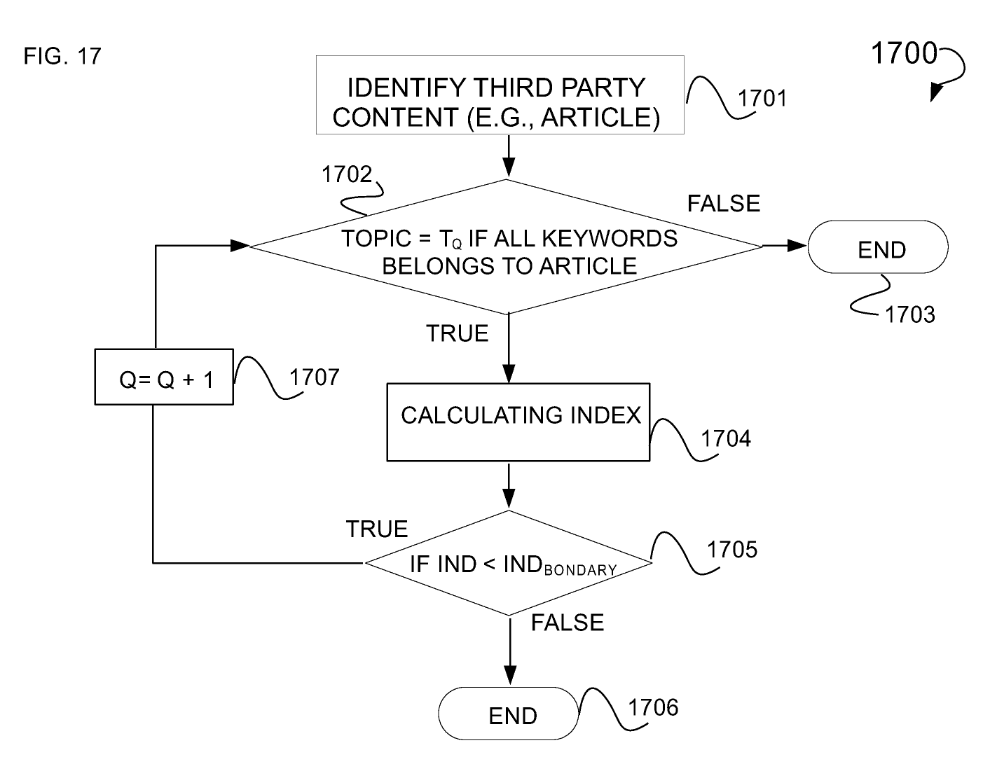

FIG. 17 is a flow chart illustrating the execution of a method 1700 to recognize a topic based upon keywords. Method 1700 may be executed by the subscription management server 110. Operation 1701 is executed to identify third-party content (i.e., content in the form of digitally published content). A decision operation 1702 is executed to define a topic, when given a set of keywords. A topic is defined by a series of keywords that are associated with third-party content. In cases where decision operation 1702 evaluates to “false,” a termination condition 1703 is executed. In cases where decision operation 1702 evaluates to “true,” operation 1704 is executed. Operation 1704 is executed to calculate an index through re-indexing indexed content. (See e.g., FIG. 13). Decision operation 1705 is executed to determine if a rule constraint has been met. The rule constraint is dictated by one or more of the indexing rules. In cases where decision operation 1705 evaluates to “true,” an operation 1707 is executed that increments an index value associated with the topic. In cases where decision operation 1705 evaluates to “false,” a termination operation 1706 is executed.

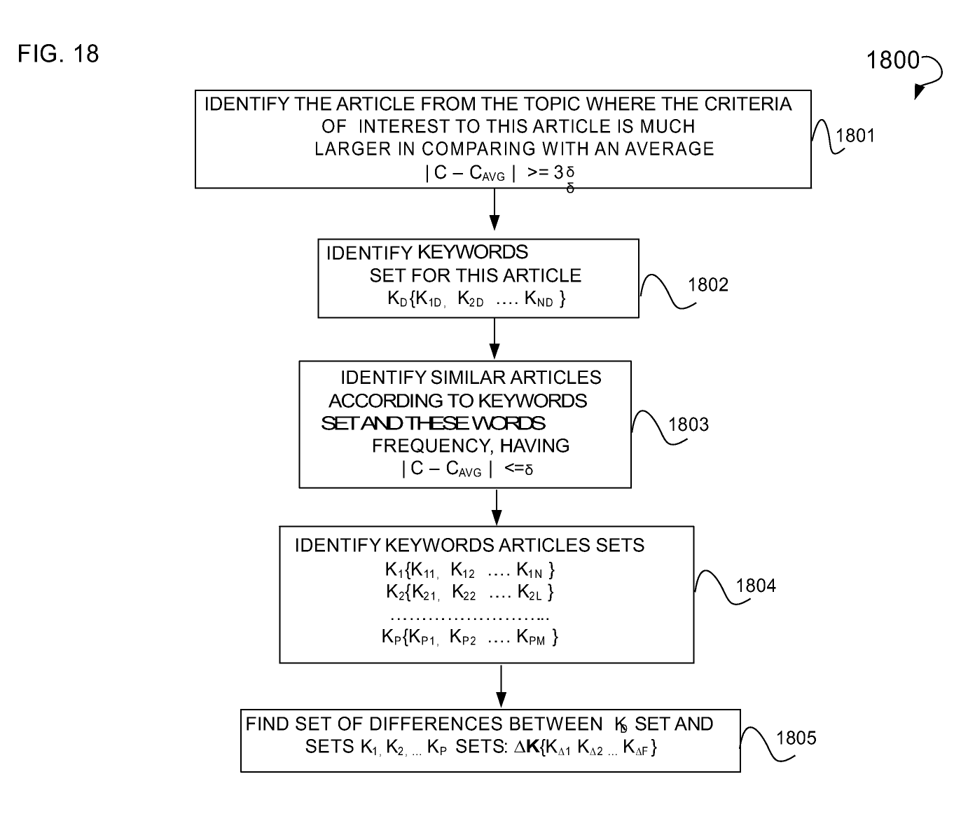

FIG. 18 is a flow chart illustrating an example method 1800 to determine a user's interests based upon the frequency of keywords. This method 1800 may be executed by the subscription management server 110 or other machine with a processor and memory. Operation 1801 is executed to identify an article (i.e., content in the form of digitally published content) from a topic where the criteria of interest in this article is larger as compared to an average. This article is representative of a topic as the criteria of interest is larger than the average level of interest. Criteria of interest, as used herein, include the frequency of a dimension (e.g., keywords, links, views, comments). Operation 1802 is executed to identify a keywords set for an article, the set including all occurrences of a keyword in the article. Operation 1803 is executed to identify similar articles based upon the common keyword sets and the frequency of keywords in the keywords sets between the articles being compared. Operation 1804 is executed to identify keywords article sets for articles. Operation 1805 is executed to find the set difference between the sets identified through the execution of operation 1804.

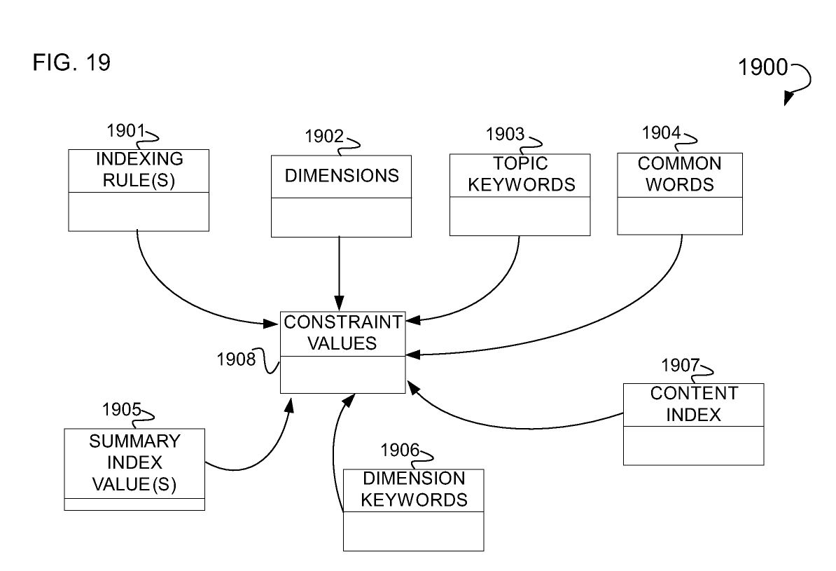

FIG. 19 is a data base schema 1900 outlining the schema for the content index store. Shown are various tables 1901-1908, which can be stored in machine readable formats on tangible media. Table 1901 includes index rules formatted using XML. Table 1902 includes dimensions formatted using an XML, string, integer or other suitable data type. Table 1903 includes topic keywords formatted using a string, Character Large Object (CLOB), or other suitable data type. Table 1904 includes common words formatted using a string, a character, or other suitable data types. Tables 1905 include summary index values for a content in the form of a digitally published content article formatted using an integer, or other suitable data type. Table 1906 includes dimension keywords, links, or reviews formatted using strings, XML, or other suitable data types. Table 1907 includes content index values formatted using an integer or other suitable data type. Table 1908 includes constraint values as keys used to access entries in the various tables 1901-1907.

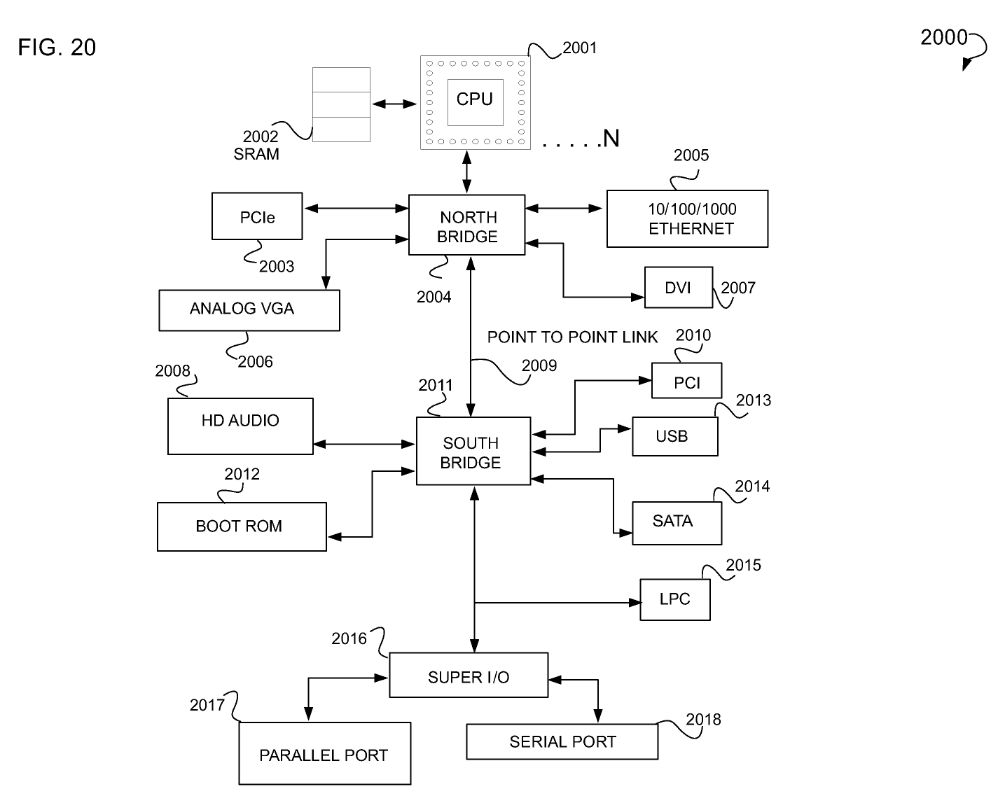

FIG. 20 is a diagram of an example computer system 2000. Shown is a Central Processing Unit (CPU) 2001. The processor die may be a CPU 2001. In some example embodiments, a plurality of CPUs may be implemented on the computer system 2000 in the form of a plurality of core (e.g., a multi-core computer system), or in some other suitable configuration. Some example CPUs include the x86 series CPU or are dedicated processing units. Operatively connected to the CPU 2001 is Static Random Access Memory (SRAM) 2002. Operatively connected includes a physical or logical connection such as, for example, a point to point connection, an optical connection, a bus connection or some other suitable connection. A North Bridge 2004 is shown, also known as a Memory Controller Hub (MCH), or an Integrated Memory Controller (IMC), that handles communication between the CPU and PCIe, Dynamic Random Access Memory (DRAM), and the South Bridge. An ethernet port 2005 is shown that is operatively connected to the North Bridge 2004. A Digital Visual Interface (DVI) port 2007 is shown that is operatively connected to the North Bridge 2004. Additionally, an analog Video Graphics Array (VGA) port 2006 is shown that is operatively connected to the North Bridge 2004. Connecting the North Bridge 2004 and the South Bridge 2011 is a point to point link 2009. In some example embodiments, the point to point link 2009 is replaced with one of the above referenced physical or logical connections. A South Bridge 2011, also known as an I/O Controller Hub (ICH) or a Platform Controller Hub (PCH), is also illustrated. A PCIe port 2003 is shown that provides a computer expansion port for connection to graphics cards and associated GPUs. Operatively connected to the South Bridge 2011 are a High Definition (HD) audio port 2008, boot RAM port 2012, PCI port 2010, Universal Serial Bus (USB) port 2013, a port for a Serial Advanced Technology Attachment (SATA) 2014, and a port for a Low Pin Count (LPC) bus 2015. Operatively connected to the South Bridge 2011 is a Super Input/Output (I/O) controller 2016 to provide an interface for low-bandwidth devices (e.g., keyboard, mouse, serial ports, parallel ports, disk controllers). Operatively connected to the Super I/O controller 2016 is a parallel port 2017, and a serial port 2018.

The SATA port 2014 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 2002 and/or within the CPU 2001 during execution thereof by the computer system 2000. The instructions may further be transmitted or received over the 10/100/1000 ethernet port 2005, USB port 2013 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

In some example embodiments, the methods illustrated herein are stored in respective storage devices, which are implemented as one or more computer-readable or computer usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) non-volatile memory, and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

The phrase “based on” as used in the present description include additional information or data be processed in conjunction with the recited basis. For example, a result based on “A”, would also include a result based at least in part on “A” (i.e., A, B, C, etc.). Accordingly, the phrase based on should be open ended and may include further processing or inputs unless explicitly excluded.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A computer implemented method comprising:
identifying, using an identification module, indexed digitally published content responsive to a search query;
generating an index value, using a indexing engine, based upon a characteristic of the indexed digitally published content; and
re-indexing, using a re-indexing module, the indexed digitally published content based upon the index value.

2. The computer implemented method of claim 1, wherein the indexed digitally published content is received from a search platform.

3. The computer implemented method of claim 1, wherein generating the index value includes:
identifying a dimension for the indexed digitally published content;
identifying a weight for the dimension; and
determining the index value as the product of the dimension and the weight.

4. The computer implemented method of claim 3, further comprising applying a rule to the index value to determine members of a set of values that make up the dimension.

5. The computer implemented method of claim 4, wherein the members include at least one of a group consisting of keywords, Uniform Resource Locator (URL) links, views, comments, sentences, and web page images.

6. The computer implemented method of claim 1, further comprising storing the index value.

7. Machine readable media storing instructions thereon for execution by a machine and when executed are operable to:
identify indexed digitally published content responsive to a search query;
generate an index value based upon a characteristic of the indexed digitally published content; and
re-index the indexed digitally published content based upon the index value.

8. The media of claim 7, wherein the indexed digitally published content is received from a search platform.

9. The media for execution of claim 7, wherein the generation of the index value includes the logic, when executed, operable to:
identify a dimension for the indexed digitally published content;
identify a weight for the dimension; and
determine the index value as the product of the dimension and the weight.

10. The media of claim 9, further comprising instructions operable to apply a rule to the index value to determine members of a set of values that make up the dimension.

11. The media of claim 10, wherein the members include at least one of keywords, Uniform Resource Locator (URL) links, views, comments, sentences, and web page images.

12. The media of claim 7, further comprising instructions operable to store the index value.

13. A computer implemented method comprising:
receiving, using a receiving module, indexed digitally published content responsive to a current content request;
generating an index value, using a indexing engine, based upon a characteristic of the indexed digitally published content; and
updating a content index, using an update module, to reflect the index value for the indexed digitally published content.

14. The computer implemented method of claim 13, further comprising receiving a search query, using an additional receiving module, that identifies the indexed digitally published content.

15. The computer implemented method of claim 13, further comprising updating the content index, using the update module, to reflect the characteristic as a dimension of the indexed digitally published content.

16. The computer implemented method of claim 15, wherein the dimension includes at least one of a popularity dimension, an information dimension, an innovation dimension, or any generated dimension.

17. The computer implemented method of claim 15, wherein the index value is calculated for each dimension.

18. The computer implemented method of claim 13, wherein the indexed digitally published content includes a Uniform Resource Locator (URL) link to digitally published content.

19. The computer implemented method of claim 13, wherein the index value is generated, in part, based upon a hash of keywords associated with the indexed digitally published content.

20. The computer implemented method of claim 13, wherein the index value is generated, in part, based upon a comparison of sets of keywords.

21. The computer implemented method of claim 3, wherein the dimensions can be built according to composite rules of the dimension.

22. The computer implemented method of claim 3, wherein the dimensions can be built according to the topological rules of the dimension.

23. The computer implemented method of claim 3, wherein the code for new dimensions can be automatically generated from the existing prototype for the set of the dimensions.

24. The computer implemented method of claim 3, wherein the dimension rules can be transformed sequentially until the criteria is met.
